(19) United States
(12) Patent Application Publication
(10) Pub. No.: US 2016/0081877 A1
(43) Pub. Date: Mar. 24, 2016

(54) Baby Spa

(71) Applicants: Ashley Marconi, Middletown, OH (US); Jessica Sizemore, Germantown, MD (US)

(72) Inventors: Ashley Marconi, Middletown, OH (US); Jessica Sizemore, Germantown, MD (US)

(21) Appl. No.: 14/864,855

(22) Filed: Sep. 24, 2015

Related U.S. Application Data
(60) Provisional application No. 62/054,798, filed on Sep. 24, 2014.

(51) Int. Cl. A61H 33/00; A47K 3/024

(52) U.S. Cl. CPC A61H 33/6005; A61H 33/0087; A47K 3/024; A61H 2201/0207; A61H 2201/5082; A61H 2201/0188; A61H 2201/1207

(57) ABSTRACT

A baby spa provides a child with comfort and relaxation by using water and multiple forms of motion. The baby spa contains a reclining motion seat, base for controlling the motion of the reclining motion seat, rotating lights, detachable mobile control device, digital thermometer for measuring water temperature, and safety system for water safety and drowning prevention. Once the baby spa is immersed in water, the reclining motion seat uses multiple reclining positions to allow water to gently glide across the child. The reclining motion seat is capable of three different motions: swaying, rocking, and vibrating. The base uses motors to control the reclining motion seat's three different motions. The detachable mobile control device controls motion and audio features of the baby spa. The reclining motion seat, rotating lights, and sounds from the detachable mobile control device works together and independently to provide a child with comfort and relaxation.

### CROSS-REFERENCE TO RELATED APPLICATIONS

This Application claims the benefit of U.S. Provisional Application No. 62/054,798, filed Sep. 24, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to a spa and in particular to a baby spa that provides a child with comfort and relaxation by using water and multiple forms of motion. Children often become irritable or fussy becomes of their environment, illness, or internal emotional state. Calming a child is a difficult task that often requires an external stimulus. Rocking motion, riding in car or stroller, water, music, and lights are examples of external stimuli known to calm and comfort a child. The baby spa would resolve this issue of calming and comforting a child.

### SUMMARY OF THE INVENTION

Accordingly, the invention is directed to a baby spa that provides a child with comfort and relaxation by using water and multiple forms of motion. The baby spa contains a reclining motion seat, base for controlling the motion of the reclining motion seat, rotating lights, detachable mobile control device, digital thermometer for measuring water temperature, and safety system for water safety and drowning prevention. Once the baby spa is immersed in water, the reclining motion seat uses multiple reclining positions to allow water to gently glide across the child. The reclining motion seat is capable of three different motions: swaying, rocking, and vibrating. The base uses motors to control the reclining motion seat's three different motions. The detachable mobile control device controls motion and audio features of the baby spa. The reclining motion seat, rotating lights, and sounds from the detachable mobile control device works together and independently to provide a child with comfort and relaxation.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 is a side view of the first exemplary embodiment, displaying the baby spa 10, light structure 20, rotating apparatus 21, lights 22, reclining motion seat 30, handle 31, rail 40, fastening elements 41, sliding support 42, base 50, motion bar 51, digital thermometer 52, suction cups 53, and release lever 54.

FIG. 2 is a side view of the first exemplary embodiment, displaying the baby spa 10, detachable mobile control device 11, light structure 20, rotating apparatus 21, lights 22, reclining motion seat 30, handle 31, rail 40, sliding support 42, base 50, motion bar 51, suction cups 53, and release lever 54.

FIG. 3 is a front view of the first exemplary embodiment, displaying the baby spa 10, light structure 20, rotating apparatus 21, lights 22, reclining motion seat 30, handle 31, 5-point safety hardness 32, rail 40, base 50, and suction cups 53.

FIG. 4 is a rear view of the first exemplary embodiment, displaying the baby spa 10, detachable mobile control device 11, light structure 20, lights 22, handles 31, rail 40, sliding support 42, base 50, suction cups 53, and release lever 54.

FIG. 5 is the top view of the detachable mobile control device 11 of the first exemplary embodiment.

### DETAILED DESCRIPTION OF THE INVENTION

Referring now to the invention in more detail, the invention is a baby spa that provides a child with comfort and relaxation by using water and multiple forms of motion. The baby spa 10 is comprised of a detachable mobile control device 11, a light structure 20, a rotating apparatus 21, lights 22, a reclining motion seat 30, handles 31, a rail 40, fastening elements 41, a sliding support 42, a base 50, a motion bar 51, a digital thermometer 52, suction cups 53, and a release lever 54.

FIG. 1 provides a side view of the baby spa 10. The light structure 20 is releasably attached to the top of the rail 40 and extends outward above the reclining motion seat 30. The light structure 20 is preferably retained in place by a relasable fasting means, for example clips or frictionally engageable components. The rotating apparatus 21 is attached on the opposite end of the light structure 20 that hangs above the reclining motion seat 30.

The rotating apparatus 21 has a circular shape and rotates about an axis that is perpendicular to its plane. Means for rotating the rotating apparatus 21 is well known in the art. Three light 22 are attached to the rotating apparatus 21 and are of equal distance from the center of the rotating apparatus 21. The lights 22 and rotating apparatus 21 are connected to electrical wiring that travels inside the rail 40 and receives electricity from a power source preferably located in the base 50.

The reclining motion seat 30 is located in the center of the baby spa 10 and contains two handles 31, each located on one side of the reclining motion seat 30. The handles 31 allow a user to lift the light weight reclining motion seat 30. A 5-point safety harness is located inside of the reclining motion seat 30 for water safety and drowning prevention.

The sliding support 42 and motion bar 51 are attached underneath the reclining motion seat 30 and are responsible for the three different motions: swaying, rocking, and vibrating. The sliding support 42 is also connected to the rail 40 in a manner that allows the reclining motion seat 30 to rock forward and backward.

The motion bar 51 is able to move forward and backward, which creates the rocking motion. The motion bar 51 also is able to move laterally, which causes the reclining motion seat 30 to sway from side to side. The motion bar 51 shakes to cause the reclining motion seat 30 to vibrate.

The motion bar 51 also is connected to the base 50. The base 50 is waterproof and houses at least one motor, a digital thermometer 52, and a power source. The motor is connected to the base 50 is such a manner to cause the motion bar 51 to rock, sway, or vibrate. The digital thermometer 52 displays the temperature of the water and is connected to sensor that detects the water temperature. The power source supplies electrical power to the motor located in the base 50 the rotating apparatus 20, and lights 22. The power source preferably uses batteries as a power source.

Suction cups 53 are located at the bottom of the base 50 and are surrounded by a non-skid bottom. The suction cups 53 allow the base 50 to be securely attached to bathroom tube while the baby spa 10 is in use. The control lever 54 releases the suction cups 53 from the bathroom tube. The control lever 54 is located on the side of the base 50.

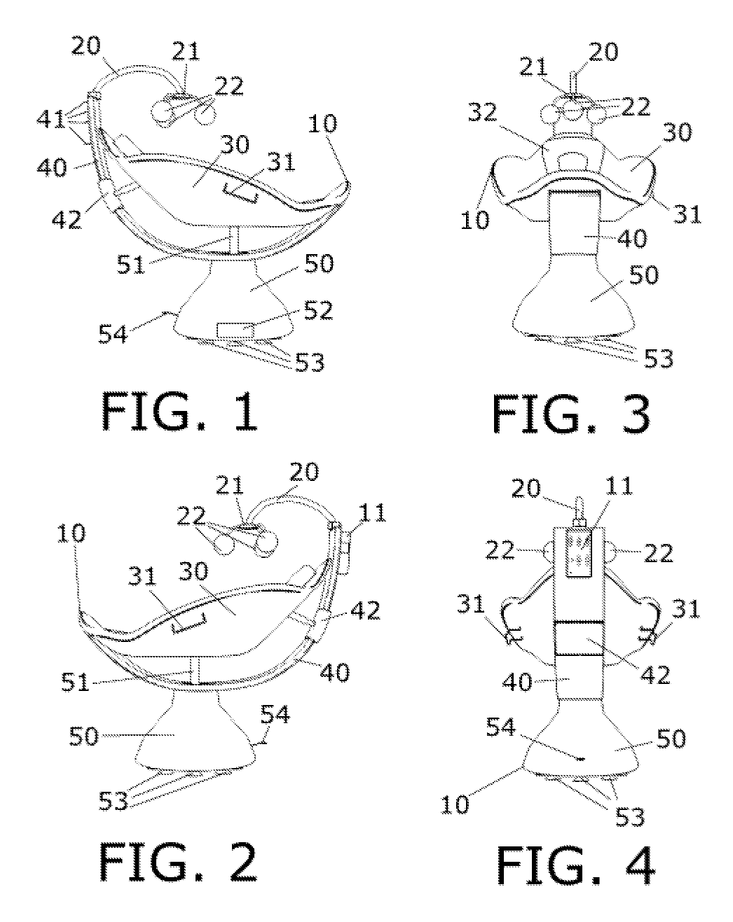

FIG. 2 shows the opposite side view of FIG. 1, in which the detachable mobile control device 11 also is attached to the fastening elements 41. The fastening elements 41 are located at the top of the rail 40 and are used for attaching the detachable mobile control device 11.

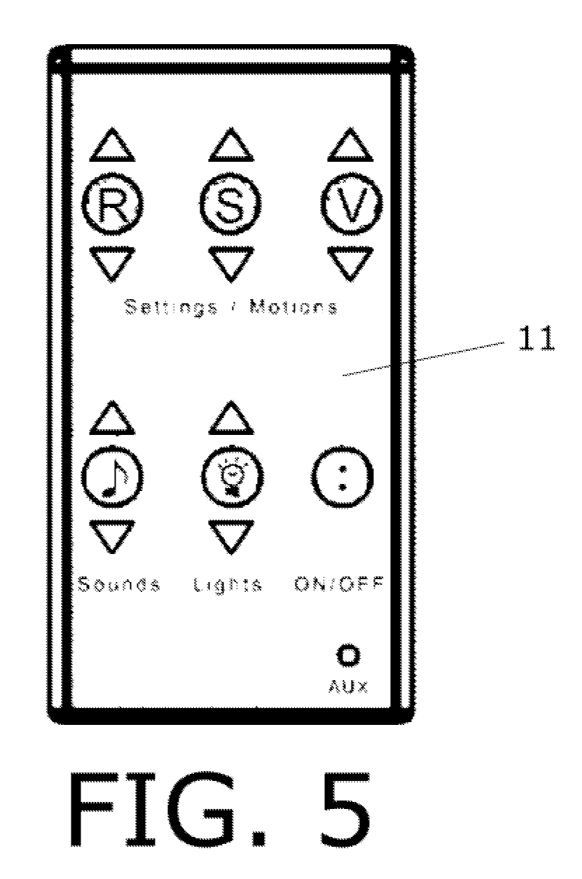

FIG. 3 shows the front view of the baby spa 10. In addition to the elements displayed in FIG. 1 and FIG. 2, FIG. 3 shows the 5-point safety hardness 32 located inside of the reclining motion seat 30.

FIG. 4 shows the back view of the baby spa 10, in which the detachable mobile control device 11 is attached to the fastening elements 41.

FIG. 5 shows the top view of the detachable mobile control device 11. The detachable mobile control device 11 controls the motion of the reclining motion seat 30, the rotating apparatus 21 and flow of power to the lights 22, and the playing of sounds. The detachable mobile control device 11 is comprised of a microprocessor, audio speakers for playing sounds, and rechargeable power source.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1) A baby spa, comprising:
(a) a reclining motion seat having two handles;
(b) a rail;
(c) a base being waterproof and having a motor, a digital thermometer, and a power source;
(d) said power source being electrically connected to said motor and being configured to provide power to said motor;
(e) a motion bar being configured to connect said reclining motion seat and said base;
(f) said motor being configured to cause said motion bar to move forward, backward, left, right, or vibrate;
(g) a sliding support;
(h) said sliding support being configured to connect said reclining motion seat and said rail;
(i) said sliding support being configured to slide along said rail;
(j) a mobile control device having a power source;
(k) said mobile control device being electrically connected to said motor;
(l) said mobile control device being configured to control said motor and said motion bar;

2) The baby spa of claim 1, wherein said base further comprises suction cups and a control lever; said suction cups being affixed to a bottom of said base; said control lever being configured to attach and release said suction cups from a surface.

3) The baby spa of claim 1, further comprising a light structure; said light structure being releasably attached to a top of said rail; said light structure being configured to extend away from said rail and over said reclining motion seat; a rotation apparatus; said rotation apparatus being affixed to an end of said light structure opposite said rail; a plurality of lights; said plurality of lights being affixed to said rotation apparatus; said rotation apparatus and said lights being electrically connected to said power source; said power source being configured to power said rotation apparatus and said lights; said rotation apparatus being circular and having an axis of rotation perpendicular to a plane of said rotation apparatus; said rotation apparatus being configured to rotate said lights around said axis of rotation.

4) The baby spa of claim 3, wherein said mobile control device is electrically connected to said rotation apparatus and said lights; said mobile control device being configured to control said rotation apparatus and said lights.

5) The baby spa of claim 3, wherein said plurality of lights are equal to three in number; said three lights being of equal distance from said axis of rotation; said three lights being of equal radial distance from each other around said axis of rotation.

6) The baby spa of claim 4, wherein said plurality of lights are equal to three in number; said three lights being of equal distance from said axis of rotation; said three lights being of equal radial distance from each other around said axis of rotation.

7) The baby spa of claim 1, wherein said reclining motion seat further comprises a safety harness.

8) The baby spa of claim 7, wherein said safety harness is a five point safety harness.

9) The baby spa of claim 1, wherein said digital thermometer is configured to measure the temperature of surrounding water.

10) The baby spa of claim 1, wherein said power source is batteries.

11) The baby spa of claim 10, wherein said batteries are rechargeable.

12) The baby spa of claim 1, further comprising fastening elements; said fastening elements being affixed to a top of said rail; said mobile control device being removably attached to said fastening elements.

13) The baby spa of claim 1, wherein said mobile control device further comprises speakers; said mobile control device being configured to play sounds.

14) The baby spa of claim 3, wherein said mobile control device further comprises speakers; said mobile control device being configured to play sounds.

15) The baby spa of claim 4, wherein said mobile control device further comprises speakers; said mobile control device being configured to play sounds.

16) The baby spa of claim 12, wherein said mobile control device further comprises speakers; said mobile control device being configured to play sounds.
